(19) United States
(12) Patent Application Publication
(10) Pub. No.: US 2018/0137149 A1
(43) Pub. Date: May 17, 2018

(54) DE-IDENTIFICATION DATA GENERATION APPARATUS, METHOD, AND NON-TRANSITORY COMPUTER READABLE STORAGE MEDIUM THEREOF

(71) Applicant: Institute For Information Industry, Taipei (TW)

(72) Inventors: Hui-I HSIAO, Yunlin County (TW); Yen-Nun HUANG, Taipei City (TW); Bo-Chen TAI, Taipei City (TW); Yi-Chen SHIH, Nantou City (TW); Yu-Shian CHIU, Taoyuan City (TW); Chia-Mu YU, Kaohsiung City (TW); Yao-Tung TSOU, Taipei City (TW)

(21) Appl. No.: 15/369,597

(22) Filed: Dec. 5, 2016

(30) Foreign Application Priority Data
Nov. 17, 2016 (TW) 105137608

(51) Int. Cl. G06F 17/30; G06F 17/18

(52) U.S. Cl. CPC G06F 17/30303; G06F 17/18; G06F 17/30598

(57) ABSTRACT

A de-identification data generation apparatus, method, and non-transitory computer readable storage medium thereof are provided. The apparatus is stored with a plurality of original records, wherein each of the records has a plurality of original values corresponding to a plurality of attributes one-to-one. The apparatus decides a plurality of attribute relations (including a user-defined attribute relation) according to the original values, wherein each attribute relation is defined by two attributes. The apparatus decides a plurality of relation groups according to the attribute relations. For each relation group, the apparatus calculates a statistical distribution of the original values corresponding to the attributes in the relation group, aggregates the statistical distribution into a plurality of sub-statistical distributions, and adds noise to each sub-statistical distribution individually. The apparatus generates a plurality of de-identification records according to the noise-added sub-statistical distributions.

### PRIORITY

This application claims priority to Taiwan Patent Application No. 105137608 filed on Nov. 17, 2016, which is hereby incorporated by reference in its entirety.

### FIELD

The present invention relates to a de-identification data generation apparatus, a de-identification data generation method, and a non-transitory computer readable storage medium thereof. Particularly, the present invention relates to a de-identification data generation apparatus, a de-identification data generation method, and a non-transitory computer readable storage medium thereof that generate de-identification data by statistical information of an original data set.

### BACKGROUND

With the rapid development in computer technologies, more and more enterprises collect, store, manipulate, and organize every kind of information/data in every kind of electronic computing apparatuses. Since business opportunities, research topics, etc. may be hidden in these huge amount of data/information, some organizations publish their data/information to the public and some enterprises sell their data/information for money. These kinds of data/information often comprises personal identification information (e.g., names and social security numbers). Therefore, these kinds of data/information must be de-identified before being published and/or sold to prevent infringement of personal privacy.

The conventional de-identification technology mainly masks or encrypts data/information of high confidential levels (e g, names and social security numbers) or reveals only a part of data/information (e.g., some digits in a numeric value). After being processed by such a de-identification technology, the reset data/information comprised in the data set is still associated with personal information. It is highly possible to derive other information associated with a certain person(s) by comparing the de-identified data set with other data sets.

Consequently, a de-identifying technology that can prevent anyone from deriving information associated with a certain person(s) based on the de-identified data is still needed in the art.

### SUMMARY

The disclosure includes a de-identification data generation apparatus. The de-identification data generation apparatus may comprise a storage unit, an interface, and a processing unit, wherein the processing unit is electrically connected to the storage unit and the interface. The storage unit is stored with an original data set, wherein the original data set comprises a plurality of original records and defines a plurality of attributes. Each of the original records has a plurality of original values corresponding to the attributes one-to-one. The interface is configured to receive a user-defined attribute relation. The processing unit is configured to decide a plurality of attribute relations according to the original values, wherein the attribute relations comprises the user-defined attribute relation and each of the attribute relations is defined by two of the attributes. The processing unit is further configured to decide a plurality of relation groups of the attributes according to the attribute relations and perform the following operations on each of the relation groups: (a) calculating a statistical distribution of the original values corresponding to the attributes comprised in the relation group, (b) aggregating the statistical distribution into a plurality of sub-statistical distributions, and (c) adding noise to each of the sub-statistical distributions to generate a noise-added sub-statistical distribution individually. The processing unit is further configured to generate a plurality of de-identification records according to the noise-added sub-statistical distributions, wherein each of the de-identification records has a plurality of de-identification data values corresponding to the attributes one-to-one.

The disclosure also includes a de-identification data generation method, which is adapted for an electronic computing apparatus. The electronic computing apparatus can be stored with an original data set, wherein the original data set comprises a plurality of original records and defines a plurality of attributes. Each of the original records has a plurality of original values corresponding to the attributes one-to-one. The de-identification data generation method comprises the following steps of: (a) receiving a user-defined attribute relation, (b) deciding a plurality of attribute relations according to the original values, wherein the attribute relations comprises the user-defined attribute relation and each of the attribute relations is defined by two of the attributes, (c) deciding a plurality of relation groups of the attributes according to the attribute relations, and (d) performing the steps (d1), (d2), and (d3) on each of the relation groups. For each of the relation groups, the step (d1) calculates a statistical distribution of the original values corresponding to the attributes comprised in the relation group, the step (d2) aggregates the statistical distribution into a plurality of sub-statistical distributions, and the step (d3) adds noise to each of the sub-statistical distributions to generate a noise-added sub-statistical distribution individually. The de-identification data generation method further comprises the step (e) for generating a plurality of de-identification records according to the noise-added sub-statistical distributions, wherein each of the de-identification records has a plurality of de-identification data values corresponding to the attributes one-to-one.

The disclosure further includes a non-transitory computer readable storage medium, which comprises a computer program stored therein. An electronic computing apparatus is stored with an original data set, wherein the original data set comprises a plurality of original records and defines a plurality of attributes. Each of the original records has a plurality of original values corresponding to the attributes one-to-one. When the computer program is loaded into the electronic computing apparatus, the electronic computing apparatus executes the de-identification data generation method described in previous paragraph.

The de-identification data generation technology (including the apparatus, the method, and the non-transitory computer readable storage medium thereof) provided in the present disclosure utilizes characteristics of the original data set (i.e., relations between the attributes and the statistical distribution of original values) for generating a plurality of desired de-identification records. Briefly speaking, the de-identification data generation technology provided herein generates a statistical distribution similar to that of the original data set by adding noise and then generates a plurality of desired de-identification records from the noise-added statistical distribution. The de-identification data generation technology provided herein takes the user-defined attribute relation into consideration in analyzing the relations between attributes of the original data set and, hence, relations between more attributes can be analyzed and taken into consideration by the user. Additionally, in order to generate a statistical distribution that is more similar to that of the original data set, the de-identification data generation technology provided herein aggregates a statistical distribution of the original values corresponding to each relation group into a plurality of sub-statistical distributions and then adds noise to the sub-statistical distributions. Consequently, the de-identification data generation technology provided herein can provide de-identification records having statistical distribution similar to that of the original data set. In addition, it is impossible for anyone to derive information associated with a certain person(s) from the de-identification records.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1A illustrates a schematic view of a de-identification data generation apparatus 1 of the first embodiment;

FIG. 1B illustrates a schematic view of an original data set 10;

FIG. 1C illustrates the attribute relations being presented and/or recorded by a dependency graph;

FIG. 1D illustrates the attribute relations including the user-defined attribute relation being presented and/or recorded by a dependency graph;

FIG. 1E illustrates the attribute groups being presented and/or recorded by a junction tree; and

FIG. 2 illustrates a flowchart of the de-identification data generation method of the second embodiment.

### DETAILED DESCRIPTION

In the following descriptions, a de-identification data generation apparatus, a de-identification data generation method, and a non-transitory computer readable storage medium thereof according certain example embodiments will be explained. However, these example embodiments are not intended to limit the present invention to any specific example, embodiment, environment, applications, or implementations described in these example embodiments. Therefore, description of these example embodiments is only for purpose of illustration rather than to limit the present invention. It shall be appreciated that, in the following embodiments and the attached drawings, elements unrelated to the present invention are omitted from depiction. In addition, dimensional relationships among individual elements in the attached drawings are illustrated only for ease of understanding but not to limit the scope of the present invention.

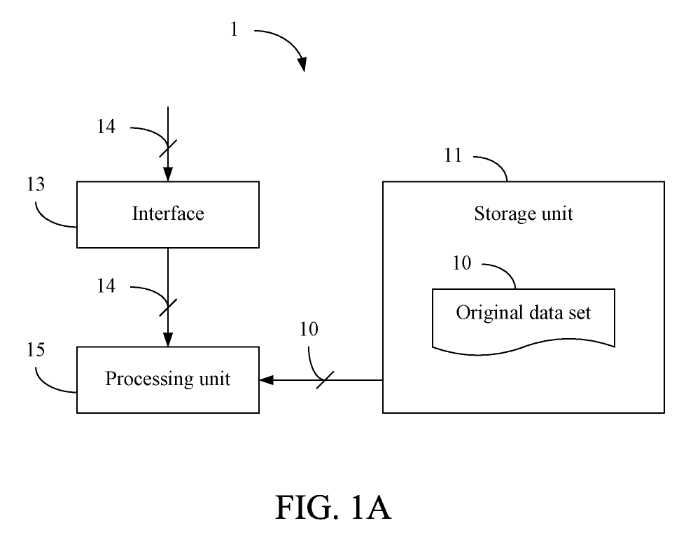

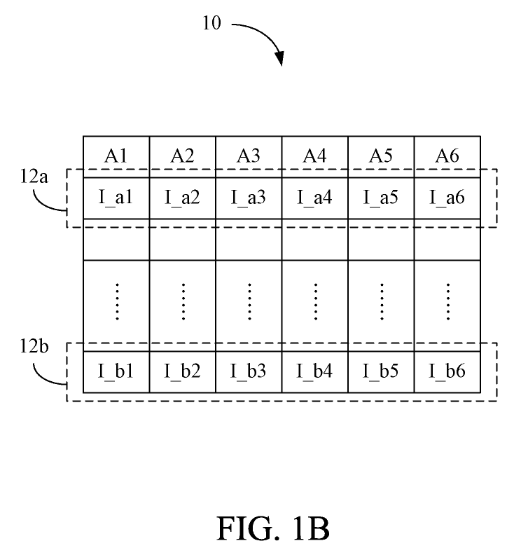

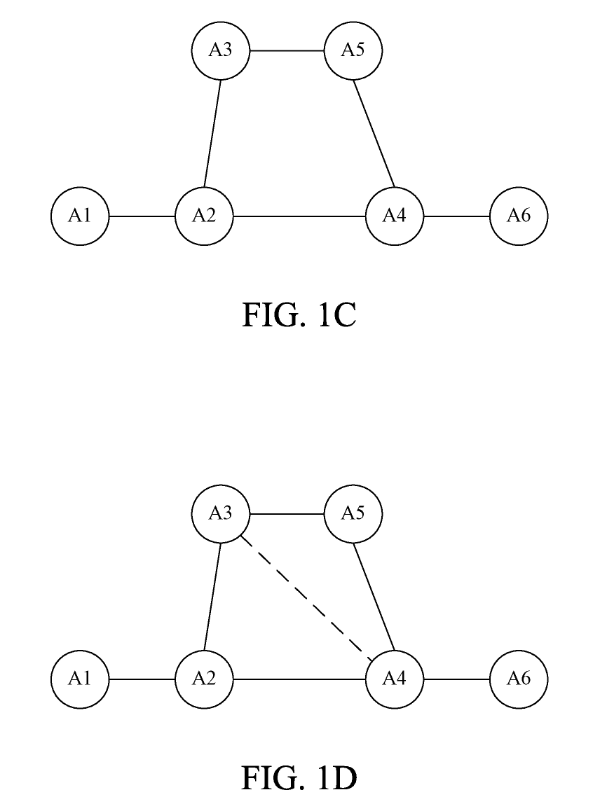

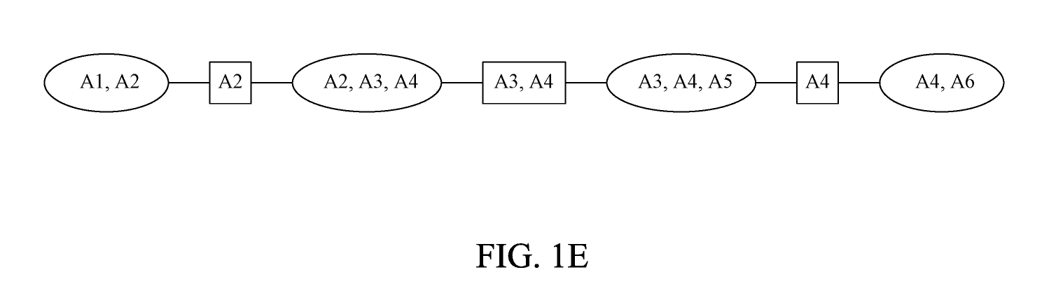

A first embodiment of the present invention is a de-identification data generation apparatus 1 and a schematic view of which is depicted in FIG. 1A. The de-identification data generation apparatus 11 comprises a storage unit 11, an interface 13, and a processing unit 15, wherein the processing unit 15 is electrically connected to the storage unit 11 and the interface 13. The storage unit 11 may be a memory, a universal serial bus (USB) disk, a hard disk, a compact disk (CD), a mobile disk, or some other storage medium or circuit with the same function and well known to those skilled in the art. The interface 13 may be any interface capable of receiving and transmitting signals. The processing unit 15 may be any of various processors, central processing units (CPUs), microprocessors, or other computing apparatuses well known to those skilled in the art.

The storage unit 11 is stored with an original data set 10 and a schematic view of which is depicted in FIG. 1B. The original data set 10 comprises a plurality of original records 12a, . . . , 12b and defines a plurality of attributes A1, A2, A3, A4, A5, A6. Each of the original records 12a, . . . , 12b has a plurality of original values corresponding to the attributes A1, A2, A3, A4, A5, A6 one-to-one. For example, the original record 1a has six original values I_a1, I_a2, I_a3, I_a4, I_a5, I_a6 corresponding to the attributes A1, A2, A3, A4, A5, A6 respectively and the original record 12b has six original values I_b1, I_b2, I_b3, I_b4, I_b5, I_b6 corresponding to the attributes A1, A2, A3, A4, A5, A6 respectively. Although the number of attributes defined in the original data set 10 is six in this embodiment, it is noted that the present invention does not require the number of attributes defined in an original data set to be any specific number.

The processing unit 15 of the de-identification data generation apparatus 1 determines which attributes among the attributes A1, A2, A3, A4, A5, A6 are highly correlated and decides the attributes that are highly correlated have attribute relation(s). Specifically, the processing unit 15 decides a plurality of attribute relations among the attributes A1, A2, A3, A4, A5, A6 according to the original values comprised in the original data set 10, wherein each of the attribute relations is defined by two of the attributes A1, A2, A3, A4, A5, A6. In some embodiments, the processing unit 15 calculates a mutual information value for each of the combinations formed by any two of the attributes A1, A2, A3, A4, A5, A6 and then determines whether the mutual information value is greater than a preset threshold value (not shown). If the mutual information value is greater than the preset threshold value, the processing unit 15 decides that the two attributes corresponding to the mutual information value have an attribute relation therebetween. For example, the processing unit 15 may calculate a mutual information value between any two of the attributes according to the following equation:

$$I ( {A}_{k} , {A}_{l} ) = {\sum }_{i = 1}^{\vert {Ω}_{k} \vert} {\sum }_{j = 1}^{\vert {Ω}_{l} \vert} {p}_{ij} log \frac{{p}_{ij}}{{p}_{i} \cdot {p}_{j}}$$

In the above equation, the parameter Aₖ represents the k^{th} attribute, the parameter Aₗ represents the l^{th} attribute, the parameter Ωₖ represents a set formed by the original values comprised in the k^{th} attribute, the parameter Ω/represents a set formed by the original values comprised in the l^{th} attribute, |Ωₖ| represents the number of the original values comprised in the k^{th} attribute, |Ωₗ| represents the number of the original values comprised in the l^{th} attribute, the parameter pⱼ represents the probability that the i^{th} original value of the k^{th} attribute appears in the k^{th} attribute, the parameter pⱼ represents the probability that the j^{th} original value of the l^{th} attribute appears in the l^{th} attribute, the parameter pᵢⱼ represents the probability that the i^{th} original value of the k^{th} attribute and the j^{th} original value of the l^{th} attribute appear at the same time, and the function I (Aₖ, A ₁) represents a mutual information value between the k^{th} attribute and the l^{th} attribute.

For ease of the subsequent description, it is assumed that the processing unit 15 decides that the attributes A1 and A2 have an attribute relation therebetween, the attributes A2 and A3 have an attribute relation therebetween, the attributes A2 and A4 have an attribute relation therebetween, the attributes A3 and A5 have an attribute relation therebetween, the attributes A4 and A5 have an attribute relation therebetween, and the attributes A4 and A6 have an attribute relation therebetween. It is noted that the attribute relations provided herein are just for illustration but not for limiting the scope of the present invention. In some embodiments, the processing unit 15 may use a dependency graph to present and/or record the attribute relations as shown in FIG. 1C.

In addition to these attribute relations decided by the processing unit 15, the user may decide that any other two attributes has an attribute relation therebetween. Specifically, the user may input at least one user-defined attribute relation 14 via the interface 13. Upon the user's input, the interface 13 receives the at least one user-defined attribute relation 14 accordingly. Each of the at least one user-defined attribute relation 14 is also defined by two of the attributes A1, A2, A3, A4, A5, A6. The processing unit 15 adds the at least one user-defined attribute relation 14 to the attribute relations decided by the processing unit 15 so that the at least one user-defined attribute relation 14 becomes a member (or members) of the attribute relations. For ease of the subsequent description, it is assumed that the user-defined attribute relation 14 received by the interface 13 is defined by the attributes A3 and A4. It is noted that the user-defined attribute relation 14 provided herein is only for illustration but not for limiting the scope of the present invention. Similarly, in some embodiments, the processing unit 15 may use a dependency graph to present and/or record the attribute relations including the user-defined attribute relation 14 as shown in FIG. 1D.

As described above, in this embodiment, the processing unit 15 of the de-identification data generation apparatus 1 decides the attribute relations (i.e., the attribute relations between the attributes A1 and A2, between the attributes A2 and A3, between the attributes A2 and A4, between the attributes A3 and A5, between the attributes A4 and A5, and between the attributes A4 and A6) at first and then adds the user-defined attribute relation 14 received by the interface 13 (i.e., the user-defined attribute relation 14 between the attributes A3 and A4) to these attribute relations. In other embodiments, the interface 13 may receive the user-defined attribute relation 14 at first and then the processing unit 15 will treat the user-defined attribute relation 14 as one of the decided attribute relations no matter whether the mutual information value between the two attributes corresponding to the user-defined attribute relation 14 is greater than the preset threshold value or not.

Next, the processing unit 15 decides a plurality of relation groups of the attributes A1, A2, A3, A4, A5, A6 according to the attribute relations (i.e., the attribute relations between the attributes A1 and A2, between the attributes A2 and A3, between the attributes A2 and A4, between the attributes A3 and A5, between the attributes A4 and A5, between the attributes A4 and A6, and between the attributes A3 and A4). For ease of understanding, it is assumed that four relation groups are decided by the attribute relations, where the first relation group comprises the attributes A1 and A2, the second relation group comprises the attributes A2, A3 and A4, the third relation group comprises the attributes A3, A4 and A5, and the fourth relation group comprises the attributes A4 and A6.

In some embodiments, the processing unit 15 may use a dimension-reduction algorithm to decide the relation groups of the attributes A1, A2, A3, A4, A5, A6. For example, the dimension-reduction algorithm may be a Bayesian network dimension-reduction algorithm or a Markov triangle dimension-reduction algorithm. In some embodiments, the processing unit 15 may adopt a junction tree to present and/or record the attribute groups as shown in FIG. 1E.

For each of the relation groups (i.e., the first relation group, the second relation group, the third relation group, and the fourth relation group), the processing unit 15 performs the following operations: (a) calculating a statistical distribution of the original values corresponding to the attributes comprised in the relation group, (b) aggregating the statistical distribution into a plurality of sub-statistical distributions, and (c) adding noise to each of the sub-statistical distributions to generate a noise-added sub-statistical distribution individually. In some embodiments, the processing unit 15 further normalizes each of the noise-added sub-statistical distributions. The purpose of the operation (b) is to aggregate the statistical numbers that are relatively discrete into the same sub-statistical distribution(s) so that the differences between the statistical numbers within each sub-statistical distribution are smaller than a preset level. Regarding the operation (c), the noise is added to each of the sub-statistical distributions individually and, hence, the added noise has little influence on the sub-statistical distributions and the original statistical characteristics will be maintained to a great extent.

Now, the description is given by taking the first relation group as an example. The processing unit 15 calculates a statistical distribution of the original values corresponding to the attributes A1 and A2 comprised in the first relation group. Then, the processing unit 15 aggregates the statistical distribution into a plurality of sub-statistical distributions, wherein the differences between the statistical numbers comprised in a same sub-statistical distribution is smaller than a preset level (i.e., the differences are not great). Subsequently, the processing unit 15 adds noise to each of the sub-statistical distributions to generate a noise-added sub-statistical distribution individually and normalizes each of the noise-added sub-statistical distributions. The processing unit 15 will perform the same operations to the rest relations groups and the description of which will not be repeated herein.

Thereafter, the processing unit 15 generates a plurality of de-identification records according to the noise-added sub-statistical distributions of all the relation groups (i.e., the first relation group, the second relation group, the third relation group, and the fourth relation group), where each of the de-identification records has a plurality of de-identification data values corresponding to the attributes one-to-one.

According to the above descriptions, the de-identification data generation apparatus 1 utilizes characteristics of the original data set 10 (i.e., relations between the attributes A1, A2, A3, A4, A5, A6 and the statistical distribution of original values) to generate a statistical distribution similar to that of the original data set 10 by adding noise and then generates a plurality of desired de-identification records from the noise-added statistical distribution. The de-identification data generation apparatus 1 takes the user-defined attribute relation 14 into consideration in analyzing the relations between attributes A1, A2, A3, A4, A5, A6 of the original data set 10 and, hence, relations between more attributes can be analyzed and taken into consideration by the user. Additionally, in order to generate a statistical distribution that is more similar to that of the original data set 10, the de-identification data generation apparatus 1 aggregates a statistical distribution of the original values corresponding to each relation group into a plurality of sub-statistical distributions and then adds noise to the sub-statistical distributions. Therefore, the de-identification data generation apparatus 1 can provide de-identification records having statistical distribution similar to that of the original data set 10. In the meantime, it is impossible for anyone to derive information associated with a certain person(s) from the de-identification records generated by the de-identification data generation apparatus 1.

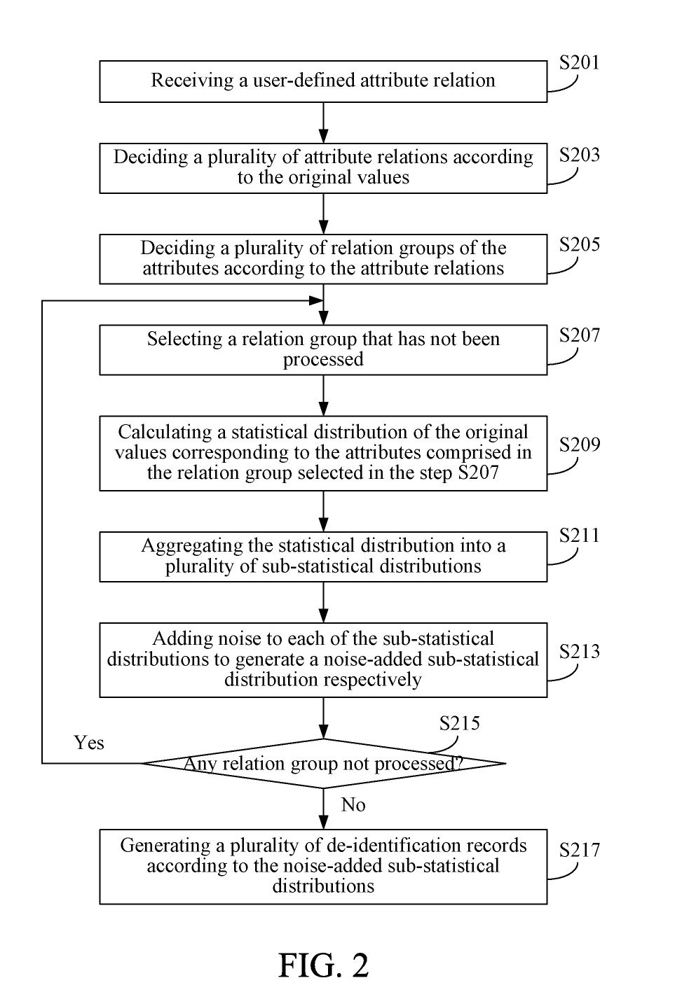

A second embodiment of the present invention is a de-identification data generation method and a flowchart of which is depicted in FIG. 2. The de-identification data generation method is adapted for an electronic computing apparatus, e.g., the de-identification data generation apparatus 1 described in the first embodiment. The electronic computing apparatus is stored with an original data set, wherein the original data set comprises a plurality of original records and defines a plurality of attributes. Each of the original records has a plurality of original values corresponding to the attributes one-to-one.

First, step S201 is executed by the electronic computing apparatus for receiving a user-defined attribute relation, wherein the user-defined attribute relation is defined by two of the attributes. Then, step S203 is executed by the electronic computing apparatus for deciding a plurality of attribute relations according to the original values, wherein the attribute relations comprises the user-defined attribute relation and each of the attribute relations is defined by two of the attributes. In some embodiments, the step S203 is executed by the electronic computing apparatus for calculating a mutual information value for each of the combinations formed by any two of the attributes and then determining whether the mutual information value is greater than a preset threshold value (not shown). If a mutual information value is greater than the preset threshold value, the electronic computing apparatus decides that there is an attribute relation between the two attributes corresponding to the mutual information value.

It shall be appreciated that, in some embodiments, the electronic computing apparatus may decide the attribute relations and then add the user-defined attribute relation received in the step S201 to these attribute relations. For those embodiments, the electronic computing apparatus may execute the step S201 for receiving the user user-defined attribute relation after the step S203. Additionally, in some embodiments, the electronic computing apparatus may set the user-defined attribute relation received in the step S201 as an attribute relation that has to be processed and, as a consequence, the electronic computing apparatus will keep the user-defined attribute relation when executing the step S203.

Next, step S205 is executed by the electronic computing apparatus for deciding a plurality of relation groups of the attributes according to the attribute relations. In some embodiments, the step S205 decides the relation groups of the attributes according to a dimension-reduction algorithm. For example, the dimension-reduction algorithm may be one of a Bayesian network dimension-reduction algorithm and a Markov triangle dimension-reduction algorithm.

Then, for each of the relation groups, the electronic computing apparatus executes steps S207 to S215. In the step S207, the electronic computing apparatus selects a relation group that has not been processed. Then, the step S209 is executed by the electronic computing apparatus for calculating a statistical distribution of the original values corresponding to the attributes comprised in the relation group selected in the step S207. Next, the step S211 is executed by the electronic computing apparatus for aggregating the statistical distribution into a plurality of sub-statistical distributions. Following that, the step S213 is executed by the electronic computing apparatus for adding noise to each of the sub-statistical distributions to generate a noise-added sub-statistical distribution individually. In some embodiments, an additional step (not shown) following the step S213 may be executed by the electronic computing apparatus for normalizing the noise-added sub-statistical distributions. Afterwards, the step S215 is executed by the electronic computing apparatus for determining any relation group is still not processed. If the determination result of the step S215 is “Yes,' the de-identification data generation method repeats the steps S207 to S215 to process the next relation group.

If the determination result of the step S215 is “No,” step S217 is executed by the electronic computing apparatus. In the step S217, the electronic computing apparatus generates a plurality of de-identification records according to the noise-added sub-statistical distributions, wherein each of the de-identification records has a plurality of de-identification data values corresponding to the attributes one-to-one.

In addition to the aforesaid steps, the second embodiment can also execute all the operations and steps of, and have the same functions and deliver the same technical effects as the first embodiment. How the second embodiment executes these operations and steps and has the same functions and delivers the same technical effects will be readily appreciated by those of ordinary skill in the art based on the explanation of the first embodiment, and thus will not be further described herein.

The de-identification data generation method described in the second embodiment may be implemented by a computer program comprising a plurality of codes. The computer program is stored in a non-transitory computer readable storage medium. When the computer program is loaded into an electronic computing apparatus (e.g., the de-identification data generation apparatus 1 in the first embodiment), the computer program executes the de-identification data generation method described in the second embodiment. The non-transitory computer-readable storage medium may be an electronic product, such as a read only memory (ROM), a flash memory, a floppy disk, a hard disk, a compact disk (CD), a mobile disk, a magnetic tape, a database accessible to networks, or any other storage media with the same function and well known to those skilled in the art.

It shall be appreciated that, in the specification of the present invention, the terms “first,” “second,” “third,” and “fourth” used in the first relation group, the second relation group, the third relation group, and the fourth relation group are only intended to indicate that these relation groups are different from each other.

According to the above descriptions, the de-identification data generation technology (including the apparatus, the method, and the non-transitory computer readable storage medium thereof) provided in the present invention utilizes characteristics of the original data set (i.e., relations between the attributes and the statistical distribution of original values) to generate a statistical distribution similar to that of the original data set by adding noise and then generate a plurality of desired de-identification records from the noise-added statistical distribution. The de-identification data generation technology provided in the present invention takes the user-defined attribute relation into consideration in analyzing the relations between attributes of the original data set and, hence, relations between more attributes can be analyzed and taken into consideration by the user. Additionally, in order to generate a statistical distribution that is more similar to that of the original data set, the de-identification data generation technology provided in the present invention aggregates a statistical distribution of the original values corresponding to each relation group into a plurality of sub-statistical distributions and then adds noise to the sub-statistical distributions. Therefore, the de-identification data generation technology provided in the present invention can provide de-identification records having statistical distribution similar to that of the original data set. In the meantime, it is impossible for anyone to derive information associated with a certain person(s) from the de-identification records.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A de-identification data generation apparatus, comprising:
a storage unit, being stored with an original data set, the original data set comprising a plurality of original records and defining a plurality of attributes, each of the original records having a plurality of original values corresponding to the attributes one-to-one;
an interface, being configured to receive a user-defined attribute relation; and
a processing unit, being electrically connected to the storage unit and the interface and configured to decide a plurality of attribute relations according to the original values, the attribute relations comprising the user-defined attribute relation, and each of the attribute relations being defined by two of the attributes,
wherein the processing unit is further configured to decide a plurality of relation groups of the attributes according to the attribute relations and perform the following operations on each of the relation groups: (a) calculating a statistical distribution of the original values corresponding to the attributes comprised in the relation group, (b) aggregating the statistical distribution into a plurality of sub-statistical distributions, and (c) adding noise to each of the sub-statistical distributions to generate a noise-added sub-statistical distribution individually,
wherein the processing unit is further configured to generate a plurality of de-identification records according to the noise-added sub-statistical distributions, wherein each of the de-identification records has a plurality of de-identification data values corresponding to the attributes one-to-one.

2. The de-identification data generation apparatus of claim 1, wherein the processing unit decides each of the attribute relations by performing the following operations: (d) calculating a mutual information value between the two attributes comprised in the attribute relation according to the original values corresponding to the two attributes and (e) determining that the mutual information value is greater than a preset threshold value.

3. The de-identification data generation apparatus of claim 2, wherein the processing unit calculates a mutual information value between the two attributes comprised in the user-defined attribute relation according to the original values corresponding to the two attributes, determines that the mutual information value is smaller than a preset threshold value, and takes the user-defined attribute relation as one of the attribute relations.

4. The de-identification data generation apparatus of claim 1, wherein the processing unit further takes the user-defined attribute relation as one of the attribute relations after deciding the attribute relations.

5. The de-identification data generation apparatus of claim 4, wherein the processing unit decides the relation groups of the attributes according to a dimension-reduction algorithm.

6. The de-identification data generation apparatus of claim 5, wherein the dimension-reduction algorithm is one of a Bayesian network dimension-reduction algorithm and a Markov triangle dimension-reduction algorithm.

7. The de-identification data generation apparatus of claim 1, wherein the processing unit further normalizes each of the noise-added sub-statistical distributions.

8. A de-identification data generation method, being adapted for an electronic computing apparatus, the electronic computing apparatus being stored with an original data set, the original data set comprising a plurality of original records and defining a plurality of attributes, each of the original records having a plurality of original values corresponding to the attributes one-to-one, and the de-identification data generation method comprising:
(a) receiving a user-defined attribute relation;
(b) deciding a plurality of attribute relations according to the original values, wherein the attribute relations comprises the user-defined attribute relation and each of the attribute relations is defined by two of the attributes;
(c) deciding a plurality of relation groups of the attributes according to the attribute relations;
(d) performing the following operations on each of the relation groups:
calculating a statistical distribution of the original values corresponding to the attributes comprised in the relation group;
aggregating the statistical distribution into a plurality of sub-statistical distributions; and
adding noise to each of the sub-statistical distributions to generate a noise-added sub-statistical distribution individually; and
(e) generating a plurality of de-identification records according to the noise-added sub-statistical distributions, wherein each of the de-identification records has a plurality of de-identification data values corresponding to the attributes one-to-one.

9. The de-identification data generation method of claim 8, wherein the step (b) decides each of the attribute relations by comprising: calculating a mutual information value between the two attributes comprised in the attribute relation according to the original values corresponding to the two attributes and determining that the mutual information value is greater than a preset threshold value.

10. The de-identification data generation method of claim 9, wherein the step (b) calculates a mutual information value between the two attributes comprised in the user-defined attribute relation according to the original values corresponding to the two attributes, determines that the mutual information value is smaller than a preset threshold value, and takes the user-defined attribute relation as one of the attribute relations.

11. The de-identification data generation method of claim 8, further comprising:
taking the user-defined attribute relation as one of the attribute relations after deciding the attribute relations.

12. The de-identification data generation method of claim 8, wherein the step (c) decides the relation groups of the attributes according to a dimension-reduction algorithm.

13. The de-identification data generation method of claim 12, wherein the dimension-reduction algorithm is one of a Bayesian network dimension-reduction algorithm and a Markov triangle dimension-reduction algorithm.

14. The de-identification data generation method of claim 8, further comprising:
normalizing each of the noise-added sub-statistical distributions.

15. A non-transitory computer readable storage medium, having a computer program stored therein, the computer program executing a de-identification data generation method after being loaded into an electronic computing device, the electronic computing apparatus being stored with an original data set, the original data set comprising a plurality of original records and defining a plurality of attributes, each of the original records having a plurality of original values corresponding to the attributes one-to-one, the de-identification data generation method comprising:
(a) receiving a user-defined attribute relation;
(b) deciding a plurality of attribute relations according to the original values, wherein the attribute relations comprises the user-defined attribute relation and each of the attribute relations is defined by two of the attributes;
(c) deciding a plurality of relation groups of the attributes according to the attribute relations;
(d) performing the following operations on each of the relation groups:
calculating a statistical distribution of the original values corresponding to the attributes comprised in the relation group;
aggregating the statistical distribution into a plurality of sub-statistical distributions; and
adding noise to each of the sub-statistical distributions to generate a noise-added sub-statistical distribution individually; and
(e) generating a plurality of de-identification records according to the noise-added sub-statistical distributions, wherein each of the de-identification records has a plurality of de-identification data values corresponding to the attributes one-to-one.

16. The non-transitory computer readable storage medium of claim 15, wherein the step (b) decides each of the attribute relations by the following steps of: calculating a mutual information value between the two attributes comprised in the attribute relation according to the original values corresponding to the two attributes and determining that the mutual information value is greater than a preset threshold value.

17. The non-transitory computer readable storage medium of claim 16, wherein the step (b) calculates a mutual information value between the two attributes comprised in the user-defined attribute relation according to the original values corresponding to the two attributes, determines that the mutual information value is smaller than a preset threshold value, and takes the user-defined attribute relation as one of the attribute relations.

18. The non-transitory computer readable storage medium of claim 15, further comprising:
taking the user-defined attribute relation as one of the attribute relations after deciding the attribute relations.

19. The non-transitory computer readable storage medium of claim 15, wherein the step (c) decides the relation groups of the attributes according to a dimension-reduction algorithm.

20. The non-transitory computer readable storage medium of claim 15, further comprising:
normalizing each of the noise-added sub-statistical distributions.
